(19) United States
(12) Patent Application Publication
(10) Pub. No.: US 2010/0101098 A1
(43) Pub. Date: Apr. 29, 2010

(54) Blade unit for rotary paper trimmer

(76) Inventor: Pet-Cheng Hsu, Taipei County (TW)

Correspondence Address: Pet-Cheng Hsu, P.O. Box 44-2049, Taipei, 10668, TW

(21) Appl. No.: 12/289,352

(22) Filed: Oct. 27, 2008

(51) Int. Cl. B26B 25/00

(52) U.S. Cl. 30/319

(57) ABSTRACT

A rotary paper trimmer includes work board and a blade unit is slidably engaged with the rail on the work board. The blade unit includes a space and a locking member is inserted into the space and biased by a spring. The locking member includes two hooks. A blade carrier carries a blade and includes two lugs which are inserted into two insertion holes in the blade unit. The lugs have two respective through holes with which the hooks of the locking member are engaged. The blade carrier is easily removed from the blade unit by pushing the locking member to disengage the hooks from the through holes of the lugs of the blade carrier, so that a new blade can be installed again.

### BACKGROUND OF THE INVENTION

(1) Field of the Invention

The present invention relates to a blade unit for rotary paper trimmers, and more particularly, to a replaceable blade unit for rotary paper trimmers.

(2) Description of the Prior Art

A conventional rotary paper trimmer is shown in FIGS. 6 to 8, and generally includes a work board 71 having a rail 72 and a sliding member 73 is slidably engaged with the rail 72. A blade unit 74 is connected tot eh sliding member 73 and includes at least two blades 75. The blade unit 74 is rotatable about a shaft which is perpendicular to the rail 72 and a knob 76 is rotatably connected to the sliding member 73. The knob 76 is connected with locking pieces 77 which are positioned at locked positions by a spring 78 biasing the sliding member 73.

When changing the blade 75, the knob 76 is pushed so as to remove the locking pieces 77 away from the sliding member 73, and the knob 76 is rotated to shift another blade 75 to the operation position.

However, the reaction force to the blade 75 during use is applied to the locking pieces 77 which affect the stable of the blades 75. Once the blades 75 shake during use, the trimming result will not be satisfied.

The present invention intends to provide a replaceable blade unit which includes only one blade and the blade unit can be quickly and easily removed from the trimmer and replace with a new blade.

### SUMMARY OF THE INVENTION

The present invention relates to a rotary paper trimmer which comprises a work board having a rail connected thereto and a blade unit is slidably engaged with the rail. The blade unit includes a top part, a blade carrier and a locking member, wherein the top part includes a first side and two second sides. A recess is defined in an underside of the top part and open to the two second sides. A protrusion extends from the first side and two insertion holes are defined through the first side. The locking member is movably inserted into a space defined in the top part and includes hooks which are located corresponding to the insertion holes. The blade carrier has a body which has a pressing side facing the top part and a blade is located between the pressing side and the protrusion. The body has two lugs extending from the pressing side thereof and the lugs are inserted into the insertion holes and hooked with the hooks of the locking member. Therefore, the blade carrier can be removed from the top part to replace a new blade by pushing the locking member to disengage the hooks from the lugs.

The primary object of the present invention is to provide a replaceable blade unit for a rotary paper trimmer and the blade unit includes only one blade which is firmly positioned so as to prevent from shaking during use.

Another object of the present invention is to provide a replaceable blade unit for a rotary paper trimmer wherein the blade unit can be easily removed from the work board to replace a new blade.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the rotary paper trimmer of the present invention;

FIG. 2 is an exploded view to show the rotary paper trimmer of the present invention;

FIG. 3 is a side view to show the blade unit slidably engaged with the rail of the work board of the rotary paper trimmer of the present invention;

FIG. 4 is a side view to show that the blade is connected between the top part and the blade carrier of the rotary paper trimmer of the present invention;

FIG. 5 is a cross sectional view taken along line 5-5 in FIG. 4;

FIG. 6 is a top view to show a conventional rotary paper trimmer;

FIG. 7 is a cross sectional view to show the sliding member of the conventional rotary paper trimmer, and

FIG. 8 is a cross sectional view taken alone line 8-8 in FIG. 7.

### DETAILED DESCRIPTION OF THE PREFERRED EMBODIMENT

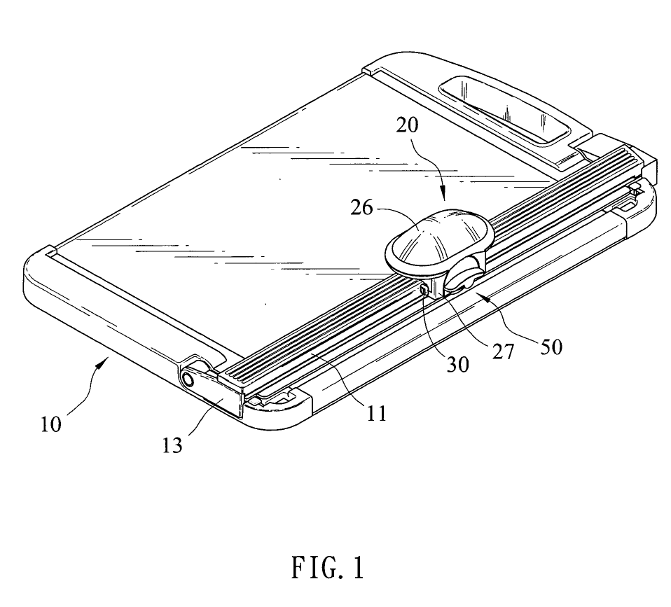

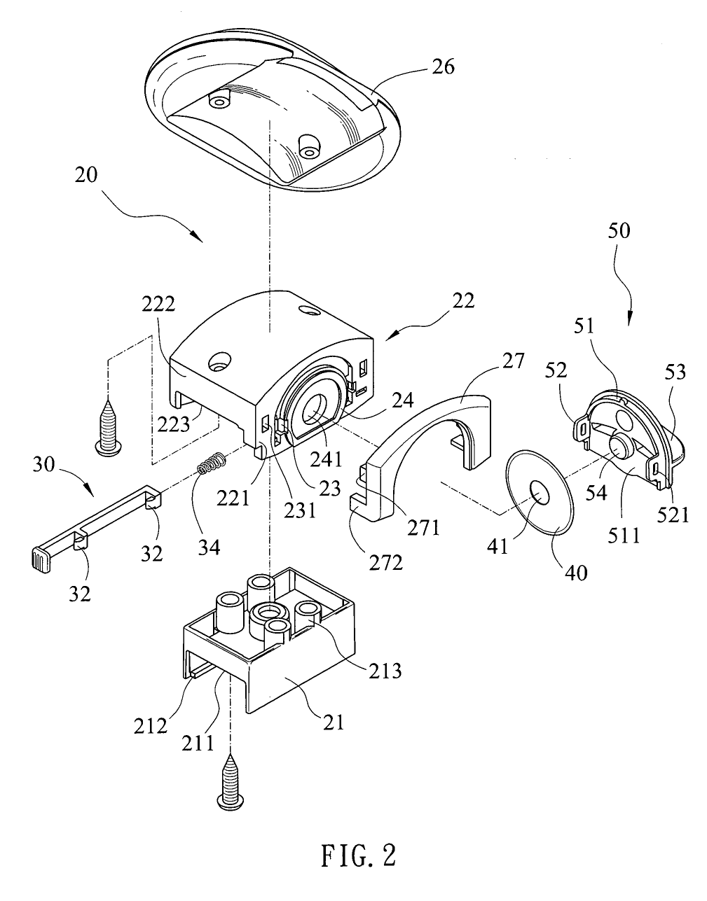

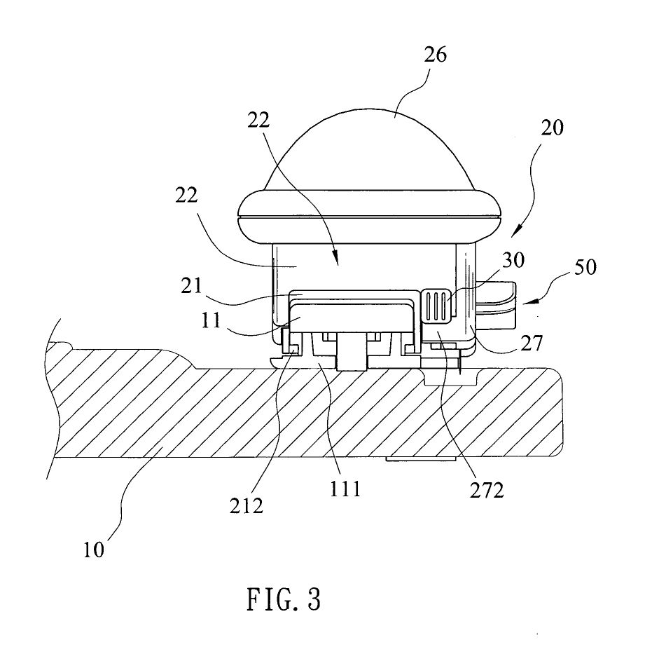

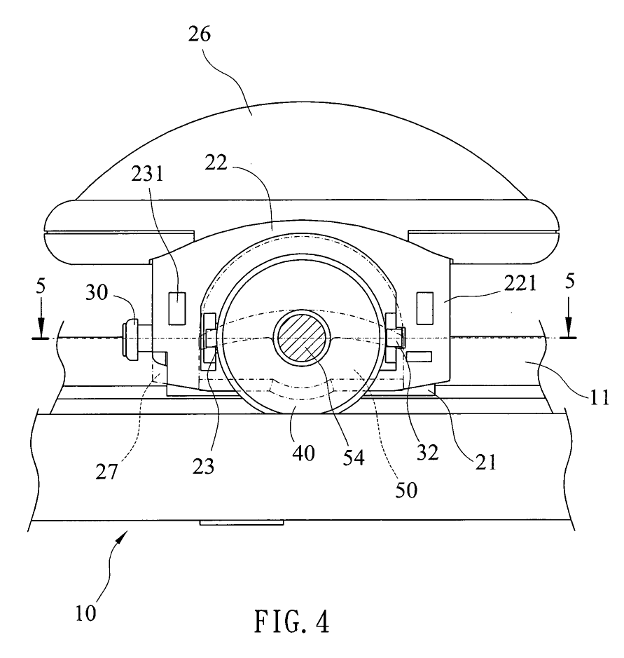

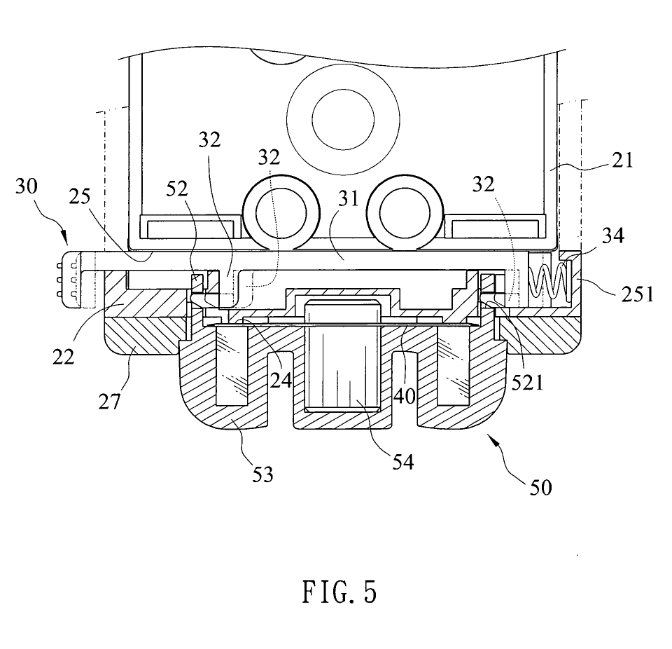

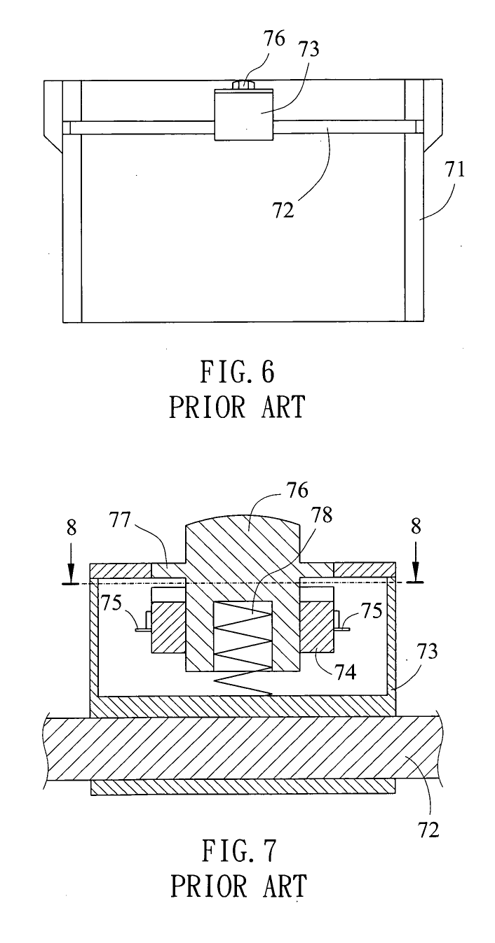

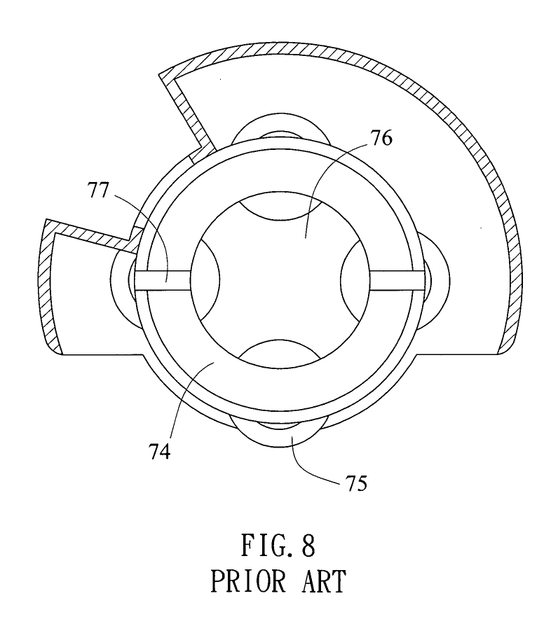

Referring to FIGS. 1 to 5, the rotary paper trimmer of the present invention comprises a work board 10 which has a rail 11 connected thereto and a blade unit 20 is slidably engaged with the rail 11. The blade unit 20 includes a top part 22, a blade carrier 50 and a locking member 30, wherein the top part 22 includes a first side 221 and two adjacent sides of the first side 221 are the second sides 222. A recess 223 is defined in an underside of the top part 22 and opens to the two second sides 222. A base 21 includes multiple tubes 213 extending from a top thereof and the base 21 is connected to the underside of the top part 22 by extending screws through the tubes 213 and connected to the top part 22. The base 21 includes a passage 211 with which the rail 11 is engaged. Two ridges 212 extend from two insides of the passage 211 and slidably contact an underside of the rail 11 so that the blade unit 20 is slidably engaged with the rail 11. A transverse edge of the recess 223 of the top part 22 is located lower than a transverse edge of the passage 211 of the base 21, so that the transverse edge of the recess 223 of the top part 22 contacts the rail 11. A space 25 is defined between an inside of the first side 221 of the top part 22 and a side of the base 21. A handle 26 is connected to a top of the top part 22.

A protrusion 24 extends from the first side 221 and two insertion holes 23 defined through the first side 221. The protrusion 24 is located between the two insertion holes 23. Two connection holes 231 are located beside the two insertion holes 23. A concavity 241 is defined in a center of the first side 221 of the top part 22 and the protrusion 24 is located around the concavity 241.

The space 25 has a closed end 251 and a spring 34 is located in the space 25. The locking member 30 includes an elongate body 31 and is movably inserted into the space 25 and the spring 34 is biased between the closed end 251 and the locking member 30. The locking member 30 includes two L-shaped hooks 32 extending from one side thereof and the two hooks are located corresponding to the insertion holes 23.

The blade carrier 50 has a body 51 which has a pressing side 511 facing the top part 22 and a blade 40 has a mounting hole 41 with which an axle 54 extending from the pressing side 511 extends. The axle 54 is inserted into the concavity 241 of the top part 22 so that the blade 40 is firmly clamped between the pressing side 511 and the protrusion 24. The body 51 has two lugs 52 extending from the pressing side 511 thereof and the axle 54 is located between the lugs 52, the lugs 52 are inserted into the insertion holes 23. The lugs 52 on the blade carrier 50 have through holes 521 to which the hooks 32 are hooked. A flange 53 extends from the body 51 and is located on a side opposite to the pressing side 511.

An arc part 27 is connected to the first side 221 of the top part 22 and includes an arc-shaped space. The body 51 of the blade carrier 50 is engaged with the arc-shaped space. Two insertions 271 extend from a side of the arc part 27 and are inserted into two connection holes 231 located beside the two insertion holes 23. The arc part 27 further has two positioning legs 272 which are engaged with two notches in the first side 221 of the top part 22.

When trimming paper, the user puts paper sheets on the work board 10 and holds the handle 26 to move the blade unit 20 along the rail 11, the blade 40 is rotated to trim the paper sheets about the axle 54.

When replacing a new blade 40, the user simply pushes the locking member 30 to remove the hooks 32 from the through holes 521 of the lugs 52 of the blade carrier 50, the user then pulls the flange 53 on the blade carrier 50 to remove the blade carrier 50 together with the blade 40 out from the top part 22. The old blade 40 can be replaced with a new one. The blade carrier 50 with the new blade 40 is then connected to the top part 22 by inserting the lugs 52 into the insertion holes 23 and the hooks 32 are pushed aside a little bit and then hooked to the through holes 521 again.

While we have shown and described the embodiment in accordance with the present invention, it should be clear to those skilled in the art that further embodiments may be made without departing from the scope of the present invention.

What is claimed is:

1. A rotary paper trimmer comprising:
work board having a rail connected thereto;
a blade unit slidably engaged with the rail and including a top part, a blade carrier and a locking member, the top part having a first side and two adjacent sides of the first side being second sides, a recess defined in an underside of the top part and opening to the two second sides, a protrusion extending from the first side and two insertion holes defined through the first side, the protrusion located between the two insertion holes, a space defined in the second side;
the locking member movably inserted into the space and having hooks which are located corresponding to the insertion holes, and
the blade carrier having a body which has a pressing side facing the top part and a blade located between the pressing side and the protrusion, the body having two lugs extending from the pressing side thereof and the lugs inserted into the insertion holes and hooked with the hooks of the locking member, the blade carrier being removed from the top part by pushing the locking member to disengage the hooks from the lugs.

2. The trimmer as claimed in claim 1, wherein a base is connected to the underside of the top part and includes a passage with which the rail is engaged, two ridges extend from two insides of the passage and slidably contact an underside of the rail, the space is defined between an inside of the first side of the top part and a side of the base, the space has a closed end and a spring is located in the space, the spring is biased between the closed end and the locking member, a handle is connected to a top of the top part and an arc part is connected to the first side of the top part, two insertions extend from a side of the arc part and are inserted into two connection holes located beside the two insertion holes, the arc part has two positioning legs which are engaged with two notches in the first side.

3. The trimmer as claimed in claim 2, wherein a concavity is defined in a center of the first side of the top part and the protrusion is located around the concavity, a transverse edge of the recess of the top part is located lower than a transverse edge of the passage of the base, the transverse edge of the recess of the top part contacts the rail.

4. The trimmer as claimed in claim 1, wherein the locking member includes an elongate body and the hooks extend from a side of the elongate body, the hooks are L-shaped hooks and the lugs on the blade carrier have through holes to which the hooks are hooked.

5. The trimmer as claimed in claim 2, wherein the body of the blade carrier is engaged with an arc-shaped space of the arc part and includes an axle located between the lugs on the pressing side, the blade has a mounting hole with which the axle engaged, a flange extends from the body and is located on a side which is opposite to the pressing side.
